(19) United States
(12) Patent Application Publication
(10) Pub. No.: US 2024/0127165 A1
(43) Pub. Date: Apr. 18, 2024

(54) INFORMATION PROCESSING METHOD

(71) Applicant: TOYOTA JIDOSHA KABUSHIKI KAISHA, Aichi-ken (JP)

(72) Inventors: Shin SAKURADA, Toyota-shi (JP); Kazuyuki INOUE, Nagoya-shi (JP); Jean-Sebastien BOIRE, Yokohama-shi (JP); Kiyonori YOSHIDA, Toyota-shi (JP); Ai MIYATA, Sakai-shi (JP); Yuki TATSUMOTO, Seto-shi (JP)

(21) Appl. No.: 18/483,527

(22) Filed: Oct. 10, 2023

(30) Foreign Application Priority Data
Oct. 12, 2022 (JP) 2022-164302

(51) Int. Cl. G06Q 10/0834; G06Q 30/0207

(52) U.S. Cl. CPC G06Q 10/0834; G06Q 30/0207

(57) ABSTRACT

An information processing method by an information processing apparatus, the information processing method including determining, as a delivery center, a first vehicle being a battery electric vehicle under energy charging or a fuel cell electric vehicle under energy fueling, and commanding a second vehicle to pick up a package from the first vehicle and deliver the package.

### CROSS-REFERENCE TO RELATED APPLICATION

This application claims priority to Japanese Patent Application No. 2022-164302, filed on Oct. 12, 2022, the entire contents of which are incorporated herein by reference.

### TECHNICAL FIELD

The present disclosure relates to an information processing method.

### BACKGROUND

Commercial electric vehicles are known (e.g., Patent Literature (PTL) 1).

### CITATION LIST

### Patent Literature

PTL 1: JP 2022-073238 A

### SUMMARY

Once vehicles leave for delivery, each vehicle travels around an area assigned to each individual vehicle. Accordingly, from an overall perspective, it is not possible to grasp the wastefulness of travel routes, the efficient timings of energy fueling, and the like.

It would be helpful to assist effective use of time for energy charging or energy fueling.

An information processing method according to an embodiment of the present disclosure is an information processing method by an information processing apparatus, the information processing method including:
determining, as a delivery center, a first vehicle being a battery electric vehicle under energy charging or a fuel cell electric vehicle under energy fueling; and
commanding a second vehicle to pick up a package from the first vehicle and deliver the package.

According to an embodiment of the present disclosure, effective use of time for energy charging or energy fueling can be assisted.

### BRIEF DESCRIPTION OF THE DRAWINGS

In the accompanying drawings:

FIG. 1 is a schematic diagram of an information processing system according to the present embodiment;

FIG. 2 is a block diagram illustrating a configuration of an information processing apparatus;

FIG. 3 is a block diagram illustrating a configuration of a first vehicle;

FIG. 4 is a diagram illustrating pickup of a package;

FIG. 5 is a diagram illustrating a data structure of a delivery plan database (DB); and

FIG. 6 is a flowchart illustrating operations of the information processing apparatus.

### DETAILED DESCRIPTION

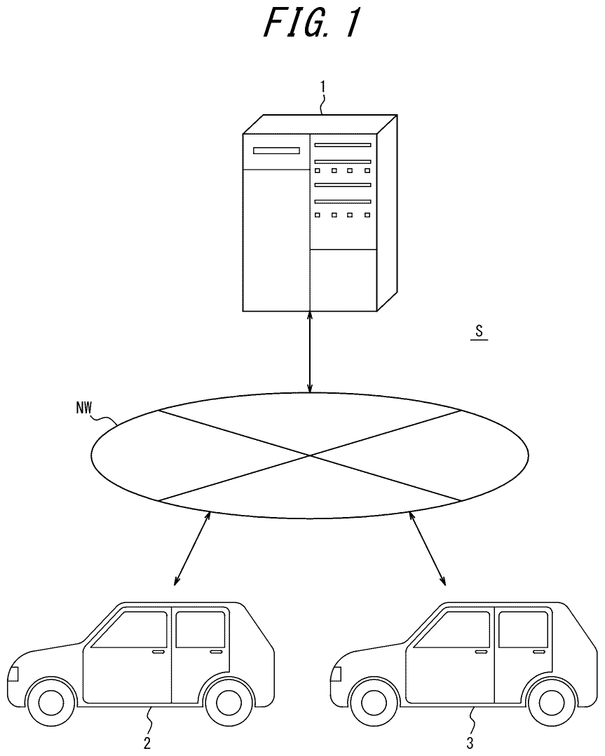

FIG. 1 is a schematic diagram of an information processing system S according to the present embodiment. The information processing system S includes an information processing apparatus 1, a first vehicle 2, and a second vehicle 3. The information processing apparatus 1 can communicate with the first vehicle 2 and the second vehicle 3 via a network NW. The network NW includes, for example, a mobile communication network, the Internet, or a fixed communication network.

FIG. 1 illustrates one each of the information processing apparatus 1, the first vehicle 2, and the second vehicle 3 for convenience of explanation. However, the numbers of information processing apparatuses 1, first vehicles 2, and second vehicles 3 are not limited to this. For example, the processing to be executed by the information processing apparatus 1 may be executed by a plurality of distributed information processing apparatuses 1. The information processing apparatus 1 may be capable of communicating with three or more vehicles.

The information processing apparatus 1 may be a server configured to assist a provider in providing a service. The information processing apparatus 1 may be, for example, installed in a facility dedicated to the provider or in a shared facility including a data center. As an alternative example, the information processing apparatus 1 may be mounted in the first vehicle 2 or second vehicle 3. The information processing apparatus 1 may be referred to as a center server.

The first vehicle 2 includes, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The driving of the first vehicle 2 may be automated at any level. The automation level is, for example, any one of Level 1 to Level 5 according to the level classification defined by SAE. The name “SAE” is an abbreviation of Society of Automotive Engineers. The first vehicle 2 may be a MaaS-dedicated vehicle. The term “MaaS” is an abbreviation of Mobility as a Service. Alternatively, the first vehicle 2 may be driven by a driver.

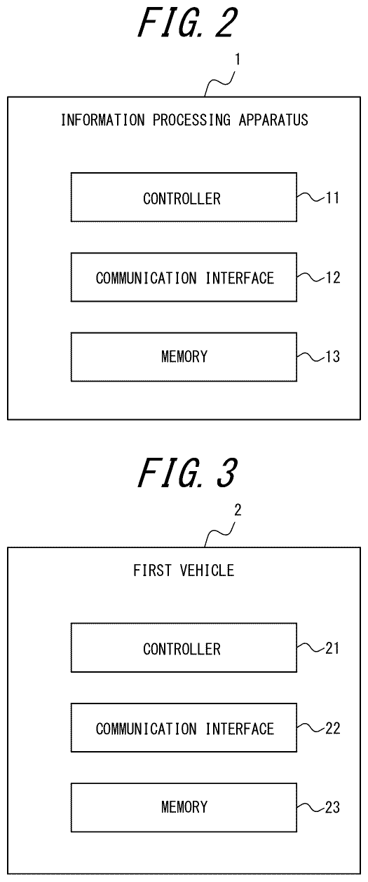

With reference to FIG. 2, an internal configuration of the information processing apparatus 1 will be described in detail.

The information processing apparatus 1 includes a controller 11, a communication interface 12, and a memory 13. The components of the information processing apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of dedicated circuits may include a Field-Programmable Gate Array (FPGA) and an Application Specific Integrated Circuit (ASIC). The controller 11 may include an Electronic Control Unit (ECU).

The communication interface 12 includes, for connecting to a network, one or more communication modules that conform to wired or wireless Local Area Network (LAN) standards. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations and control of the information processing apparatus 1. The memory 13 may store a system program, an application program, embedded software, and the like. The memory 13 may be provided outside the information processing apparatus 1 and accessed by the information processing apparatus 1. The memory 13 includes a delivery plan DB.

With reference to FIG. 3, an internal configuration of the first vehicle 2 will be described in detail.

The first vehicle 2 includes a controller 21, a communication interface 22, and a memory 23. The components of the first vehicle 2 are communicably connected to one another, for example, via dedicated lines.

Descriptions of the hardware configurations of the controller 21, communication interface 22, and memory 23 may be the same as the descriptions of the hardware configurations of the controller 11, communication interface 12, and memory 13, respectively. An explanation here is omitted.

A description of the hardware configuration of the second vehicle 3 may be the same as the description of the hardware configuration of the first vehicle 2. An explanation here is omitted.

Hereinafter, processing executed by the information processing system S according to the present embodiment will be described in detail. As an example here, the second vehicle 3 delivers packages.

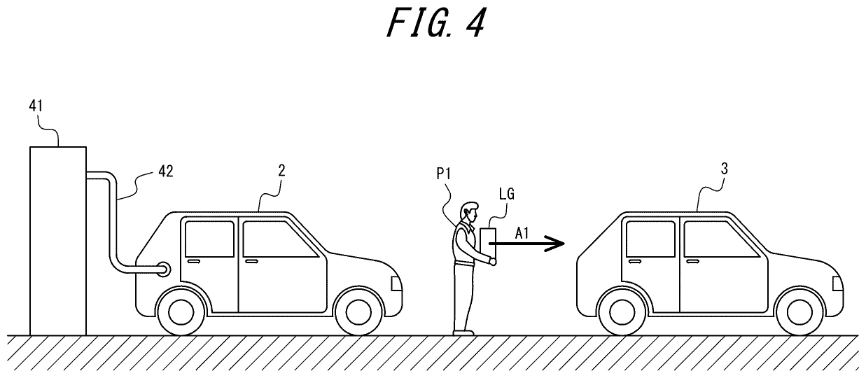

As illustrated in FIG. 4, the first vehicle 2 that is a BEV under energy charging or an FCEV under energy fueling is connected by a cable 42 to a charging or fueling apparatus 41 at a chargeable or fuelable location. Upon identifying the first vehicle 2 from position information or the like, the controller 11 of the information processing apparatus 1 determines the first vehicle 2 as a delivery center. The delivery center functions as a temporary sales office. The first vehicle 2 may be determined as a replacement delivery center for an existing nearby delivery center that is not functioning for some reason.

The controller 11 may accept packages from customers at the first vehicle 2.

The controller 11 commands the second vehicle 3 to pick up a package from the first vehicle 2 and deliver the package. Specifically, the controller 11 may indicate, to the second vehicle 3, the package to be delivered and a delivery plan. As illustrated in FIG. 4, a driver P1 of the second vehicle 3 picks up a package LG from the first vehicle 2 and moves in a direction A1 to load the package LG into the second vehicle 3.

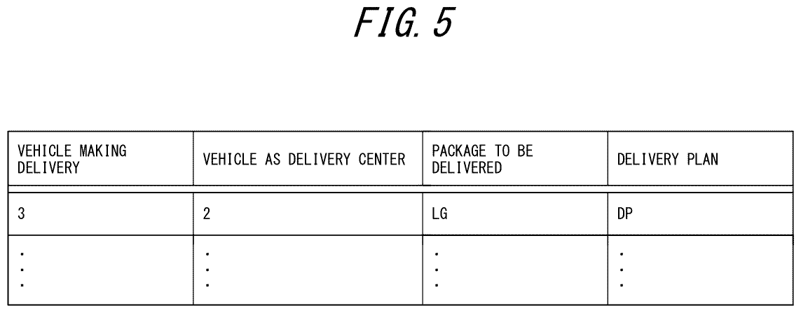

As illustrated in FIG. 5, the controller 11 stores, in the memory 13, a vehicle as a delivery center, a package to be delivered, and a delivery plan in association with a vehicle making a delivery.

The controller 11 may indicate, to the first vehicle 2, a charging plan for the BEV or a fueling plan for the FCEV. For example, the controller 11 indicates a time period for charging or fueling, the amount of charging or fueling, and the like. For example, the controller 11 may command the first vehicle 2 to stay at the same location until the packages accepted at the first vehicle 2 are handled.

The controller 11 may discount a delivery fee from a billing amount to be charged to a user who has come to the delivery center to pick up a package. For example, the controller 11 may calculate a discounted billing amount by subtracting the delivery fee from the billing amount stored in the memory 13.

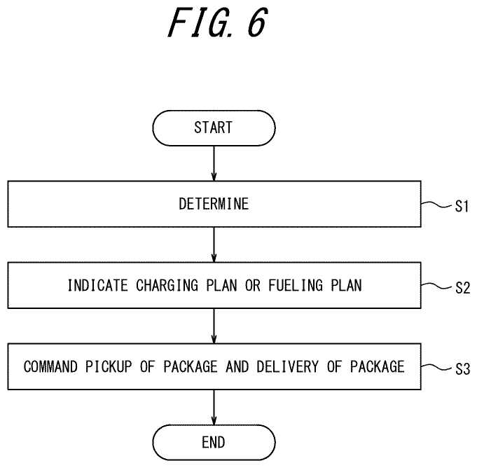

An information processing method by the information processing apparatus 1 will be described with reference to FIG. 6.

In step S1, the controller 11 of the information processing apparatus 1 determines, as a delivery center, the first vehicle 2 that is a BEV under energy charging or an FCEV under energy fueling. In step S2, the controller 11 indicates, to the first vehicle 2, a charging plan for the BEV or a fueling plan for the FCEV. Step S2 is optional. Step S2 may be performed after step S3. In step S3, the controller 11 commands the second vehicle 3 to pick up a package from the first vehicle 2 and deliver the package.

As described above, according to the present embodiment, operations of the controller 11 of the information processing apparatus 1 include determining, as a delivery center, the first vehicle 2 that is a BEV under energy charging or an FCEV under energy fueling, and commanding the second vehicle 3 to pick up a package from the first vehicle 2 and deliver the package. With this configuration, the information processing apparatus 1 can assist effective use of time for energy charging or energy fueling in the first vehicle 2.

According to the present embodiment, the operations of the controller 11 also include indicating, to the second vehicle 3, the package to be delivered and a delivery plan. With this configuration, the information processing apparatus 1 can smoothly make a delivery.

According to the present embodiment, the operations of the controller 11 also include indicating, to the first vehicle 2, a charging plan for the BEV or a fueling plan for the FCEV. With this configuration, the information processing apparatus 1 can notify the first vehicle 2 of how long charging or fueling should be performed or the like.

According to the present embodiment, the operations of the controller 11 also include discounting a delivery fee from a billing amount to be charged to a user who has come to the delivery center to pick up a package. With this configuration, the information processing apparatus 1 can reduce delivery cost while motivating users to come and pick up packages.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the aforementioned embodiment, a program configured to execute all or some of the functions or processing of the information processing apparatus 1 can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

A computer temporarily stores in a main memory, for example, the program recorded on the portable recording medium, or the program transferred from the server. Then, the computer reads the program stored in the main memory using a processor, and executes processes in accordance with the read program using the processor. The computer may read a program directly from the portable recording medium, and execute processes in accordance with the program. The computer may, each time a program is transferred from the server to the computer, sequentially execute processes in accordance with the received program. Instead of transferring the program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to the program. For example, data that is not a direct command to a computer but has a property that regulates processing of the computer is “equivalent to a program” in this context.

1. An information processing method by an information processing apparatus, the information processing method comprising:
determining, as a delivery center, a first vehicle being a battery electric vehicle under energy charging or a fuel cell electric vehicle under energy fueling; and
commanding a second vehicle to pick up a package from the first vehicle and deliver the package.

2. The information processing method according to claim 1, comprising indicating, to the second vehicle, the package to be delivered and a delivery plan.

3. The information processing method according to claim 1, comprising indicating, to the first vehicle, a charging plan for the battery electric vehicle or a fueling plan for the fuel cell electric vehicle.

4. The information processing method according to claim 1, comprising discounting a delivery fee from a billing amount to be charged to a user who has come to the delivery center to pick up a package.
